(19) United States
(12) Patent Application Publication
(10) Pub. No.: US 2017/0046813 A1
(43) Pub. Date: Feb. 16, 2017

(54) AN APPARATUS AND ASSOCIATED METHODS FOR IMAGE CAPTURE

(71) Applicant: Nokia Technologies Oy

(72) Inventors: Dongli WU, Beijing (CN); Liang ZHANG, Beijing (CN)

(21) Appl. No.: 15/106,431

(22) PCT Filed: Jan. 8, 2014
(86) PCT No.: PCT/CN2014/070309

§ 371 Date: Jun. 20, 2016

(51) Int. Cl. G06T 3/00; H04N 5/232; G06K 9/46; G06K 9/00

(52) U.S. Cl. CPC G06T 3/0093; G06K 9/0061; H04N 5/23229; G06K 9/4604; H04N 5/23293

(57) ABSTRACT

An apparatus comprising: at least one processor; and at least one memory including computer program code, the at least one memory and the computer program code configured to, with the at least one processor, cause the apparatus to perform at least the following: based on an offset, in an eye image, from an eye shape of an eye having a gaze directly at a viewer, provide a modification to a contour of an eyelid featured in the eye image for use in image manipulation to adjust the eye shape to appear as having a gaze directly at a viewer.

### TECHNICAL FIELD

The present disclosure relates to the field of user interfaces, associated methods, computer programs and apparatus. Certain disclosed aspects/examples relate to portable electronic devices, in particular, so-called hand-portable electronic devices which may be hand-held in use (although they may be placed in a cradle in use). Such hand-portable electronic devices include so-called Personal Digital Assistants (PDAs), mobile telephones, smartphones and other smart devices, smartwatches and tablet PCs.

The portable electronic devices/apparatus according to one or more disclosed aspects/embodiments may provide one or more audio/text/video communication functions (e.g. tele-communication, video-communication, and/or text transmission (Short Message Service (SMS)/Multimedia Message Service (MMS)/e-mailing) functions), interactive/non-interactive viewing functions (e.g. web-browsing, navigation, TV/program viewing functions), music recording/playing functions (e.g. MP3 or other format and/or (FM/AM) radio broadcast recording/playing), downloading/sending of data functions, image capture functions (e.g. using a (e.g. in-built) digital camera), and gaming functions.

### BACKGROUND

Certain electronic devices, for example a digital camera or a smartphone equipped with a digital camera, allow a user to capture images.

If a person looks at themselves in a mirror, they will usually look at the reflection of their eyes. The person's gaze will appear to be directly outwards from the mirror surface. However, self-portrait photography will not capture a similar “mirror” image in which the subject's gaze appears to be directly out of the photograph, unless the subject faces and gazes directly into the camera lens when taking the photograph. A camera lens by itself provides no direct visual feedback to the subject being captured by the camera lens in the way a mirror does if the subject gazes directly at their eyes in a mirror. Self-portrait photography is often implemented using a so-called front-facing camera lens of an apparatus where the subject being captured by the camera lens can view the image being captured on a display of the apparatus.

However, this inherently causes the subject's gaze to be directed towards the displayed image, and not at the camera lens. This means that when the subject views their self-portrait photograph, their eye gaze direction will be directed away from the camera lens. This gives an offset between the direction of the eye gaze directly at the camera, and the direction of the eye gaze at the displayed image when the subject captured the image. This can result in a captured image which is different to that perceived by the subject looking in a mirror; that is, if the subject had looked directly at the camera lens when taking the self-portrait. It can be very time consuming and frustrating for someone who is taking a self-portrait photograph to try to position the camera lens and/or look at the view-finder display from a different angle of view when attempting to give a natural effect as if looking in a mirror, because the act of checking the image alignment in the view-finder inherently results in the direction of the subject's gaze moving away from the direction directly towards the camera lens.

The listing or discussion of a prior-published document or any background in this specification should not necessarily be taken as an acknowledgement that the document or background is part of the state of the art or is common general knowledge. One or more aspects/examples of the present disclosure may or may not address one or more of the background issues.

### SUMMARY

In a first example aspect there is provided an apparatus comprising at least one processor and at least one memory including computer program code, the at least one memory and the computer program code configured to, with the at least one processor, cause the apparatus to perform at least the following: based on an offset, in an eye image, from an eye shape of an eye having a gaze directly at a viewer, provide a modification to a contour of an eyelid featured in the eye image for use in image manipulation to adjust the eye shape to appear as having a gaze directly at a viewer.

The eye image may be considered to be the image of a user's face including one or two eyes, or may be the image or region of an image corresponding to a user's eye, for example. A viewer may be a person viewing the eye image on a display screen. A viewer may be considered to be a camera lens of a camera used to capture an eye image. A camera may capture an eye image for displaying on a display to a viewer. A gaze directly at a viewer may be a perceived gaze direction in the image that appears to look directly out of said image, and therefore would be perceived by a viewer of said image as being directed at them. Thus the viewer can be considered to be the camera lens, because a perceived gaze directed directly at the camera lens will result in the eyes of the captured image having a gaze directly out of said image.

An offset from an eye shape of an eye having a gaze directly at a viewer in an eye image may be considered to be an eye shape which is different to (offset from) an eye shape of an eye having a gaze directly at a viewer in an eye image. For example, in the case of a person taking a self-snapshot using a smartphone having a display and front-facing camera, the eye shape of the user's eye having a gaze at the display screen during image capture will be different to (have an offset from), the eye shape of the user's eye having a gaze directly at the camera lens used to capture the self-snapshot upon image capture. The gaze of an eye in an eye image directed towards a viewer has a different orientation than the gaze of an eye in an eye image which is directed away from the viewer.

The offset of the gaze from being directed towards a viewer may be the result of a user taking a photograph of him/herself, for example using a smartphone. Such an image may be called a self-snapshot or “selfie”. A user may not look at the camera lens when capturing a self-snapshot, and instead may look at a display screen below the camera on the smartphone which is showing the image of the user's face about to be captured. Because the user may be looking below the camera, rather than at the camera, when capturing the photograph, the user's eye positions in the image may have a gaze directed away from (below) the viewer rather than at the viewer. This can look unnatural.

Advantageously, by the apparatus being configured to provide a modification to a contour of an eyelid featured in the eye image for use in image manipulation to adjust the eye shape to appear as having a gaze directly at a viewer, the eye(s) in the eye image can appear to show the expected sight line such that the eye gaze is directed towards the image viewer in the image. That is, after the modification, the user may appear to have been looking at the camera lens when the photograph was taken, even if the user was looking away from the camera (e.g., at a display screen) when taking the photograph. This can give an improved and more natural appearance of the self-snapshot photograph. This may also allow the user to capture the self-snapshot photograph while looking at the display screen, rather than the camera, which the user may find a more intuitive way of taking a self-snapshot than looking away from the display at a camera. The modification provided by the apparatus may in some examples be an actual modification/alteration to the image. In other examples the modification provided by the apparatus may be the provision of a modification profile, such as a set of instructions or model with which another apparatus (or the same apparatus) can modify the image and/or subsequent images.

The eyelid may comprise an upper eyelid of an eye in said eye image. If a user is looking below a camera when capturing a self-snapshot, the user's upper eyelid is likely to be lower than if the user is looking up at the camera. Thus by adjusting the upper eyelid shape in the image so that the user appears to be looking out from the image at the viewer rather than away from a viewer, a more natural photo may be achieved.

Said modification may provide a modification profile, said modification profile derived by a comparison between said eye image featuring an eye of a user not looking directly at a camera that is used to capture said eye image and a second, reference eye image featuring the eye of the user looking directly at the camera. The user may, for example, capture a reference eye image while looking at the camera. After taking this reference image, subsequent images may be captured while the user is not necessarily looking at the camera, and by comparison with the reference image, a difference between the two images regarding eye shape may be determined (providing at least part of a modification profile) to allow for modification of the subsequently captured image. Thus the apparatus may be used to determine a modification which forms a modification profile from two test images; one of the user looking directly at the camera and another where they are not. The modification profile thus forms a reference modification for use in determining the offset for subsequent modifications on subsequent eye images.

The eye image may comprise one or two eyes. The eye image featuring an eye of a user not looking directly at a camera may be captured when the user is looking at a display screen or viewfinder of, for example, a smartphone or digital camera, rather than at the camera directly. The apparatus configured to provide the modification to a contour of an eyelid featured in the eye image may, in some examples, be the same apparatus configured to determine the modification profile.

Said modification profile may be associated with identification information of said user and said identification information may be used to select said modification profile for use in the modification of subsequent eye images featuring said user. For example, facial recognition (which may not may not be carried out by the same apparatus configured to provide the modification to a contour of an eyelid featured in the eye image) may be used to determine the identity of the current user and used to determine which modification profile or reference image is appropriate for use in comparing with a subsequent image of a particular user.

Said modification profile may comprise a reference modification derived from a determined difference between a first contour corresponding to an upper eyelid in the eye image and a second reference contour corresponding to the same upper eyelid as depicted in the second eye image.

Said modification profile may additionally include iris repositioning data derived by a comparison between a first relative position of an iris in the eye image and a second relative reference position of the same iris as depicted in the second eye image. The relative positions may comprise the position of the iris relative to a different part of the eye in each of the eye image and second eye image. Thus the iris position relative to the eyelids may be used.

Said offset may be determined using a predetermined modification profile representing a normalisation modification to adjust the eye shape from an eye having a gaze not directly at a viewer to a gaze directly at said viewer. The same apparatus configured to provide the modification profile may in some examples also determine the offset. The predetermined modification may be, for example, an adjustment of regions of an upper eyelid contour by a particular number of pixels, and may include an adjustment of an iris and pupil position.

The effect of the modification profile may be based on a determined distance indicative of the distance said eye is from a camera used to capture said eye image. A larger distance between the user's eye/face and the camera may require a smaller modification of the eye shape to adjust the eye gaze direction. The distance may be determined by a comparison between said eye image and a reference image used to form said modification profile.

The apparatus may be configured to, in response to receipt of the eye image, perform feature detection to identify the contour in the eye image corresponding to an eyelid of the eye featured in said eye image. The apparatus may be configured, for example, to perform edge detection and/or facial/eye recognition to identify an eyelid contour.

The apparatus may be further configured to, based on an offset, in the eye image, from an iris position of an eye having a gaze directly at a viewer, provide a further modification to an image area containing said iris for use in image manipulation to adjust the iris position to appear as having a gaze directly at a viewer. Thus, the apparatus may be configured to provide a modification to an eyelid contour and provide a modification to an iris region of an eye image. Modifying the eyelid contour and iris position may provide a more natural modified image.

The apparatus may be further configured to use said modification to modify said eye image such that the eye appears to have a gaze directly at a viewer.

The contour may comprise an area corresponding to an upper eyelid featured in said eye image. Thus the contour may, for example, outline/bound the upper eyelid region, for example.

Said apparatus may comprise a front-facing camera and a front-facing display, said front-facing display configured to display images captured by said camera, and wherein said offset comprises the difference in eye shape between an eye looking directly at the display and an eye looking directly at the camera. For example, a user taking a self-snapshot may view him/herself on the front-facing display and capture the image using the front-facing camera.

Said eye image may comprise a live image, and said apparatus may be configured to provide for display, in real time, a manipulated image created using said modification. Thus, for example, a user holding a smartphone with a front-facing camera and display screen facing towards his face may see an adjusted image in real-time on the display screen as if looking in a mirror. If the user looks up at the camera then no modification to the eye position may be applied. If the user looks at the display screen, then a modification to the eye shape may be applied in real time to look as if the user is looking at the camera (and thus have a gaze directed towards a viewer, who in this case is the user).

The apparatus may be configured to use feature detection to identify a user present in said eye image and select a corresponding modification profile. Advantageously, for example, facial recognition may be used to identify a user in an image from detecting the user's features and a modification profile may be selected for that identified user to determine the offset and modification required.

The eye image may comprise a selfie image and said apparatus may be configured to provide said modification to alter the shape of the contour to adjust the apparent gaze of a user featured in said selfie image such that it appears to be directed directly at a viewer of said eye image. In some examples the selfie image may comprise an image of one user. In other examples the selfie image may comprise images of two or more users. For example one user may hold the device to take an image of himself with a friend stood close by. Modifications may be made to all the eyes in the image which may be adjusted so that the gaze is directed to a viewer of the image.

The apparatus may be a portable electronic device, a laptop computer, a mobile phone, a smartphone, a tablet computer, a smart television, a personal digital assistant, a navigation device, a watch, a digital camera, a non-portable electronic device, a server, a desktop computer, a monitor/display, or a module/circuitry for one or more of the same.

In a further aspect there is provided a method, the method comprising based on an offset, in an eye image, from an eye shape of an eye having a gaze directly at a viewer, providing a modification to a contour of an eyelid featured in the eye image for use in image manipulation to adjust the eye shape to appear as having a gaze directly at a viewer.

In a further aspect there is provided a computer readable medium comprising computer program code stored thereon, the computer readable medium and computer program code being configured to, when run on at least one processor, perform at least the following: based on an offset, in an eye image, from an eye shape of an eye having a gaze directly at a viewer, provide a modification to a contour of an eyelid featured in the eye image for use in image manipulation to adjust the eye shape to appear as having a gaze directly at a viewer.

In a further aspect there is provided an apparatus, the apparatus comprising means for providing a modification to a contour of an eyelid featured in an eye image for use in image manipulation to adjust the eye shape to appear as having a gaze directly at a viewer based on an offset, in the eye image, from an eye shape of an eye having a gaze directly at a viewer.

The apparatus may comprise means for providing a modification to a contour of an upper eyelid featured in said eye image for use in image manipulation.

The apparatus may comprise means for providing a modification profile, said modification profile derived from said modification to said contour of said eyelid featured in said eye image for use in image manipulation, said modification profile derived by a comparison between said eye image featuring an eye of a user not looking directly at a camera that is used to capture said eye image and a second, reference eye image featuring the eye of the user looking directly at the camera.

The apparatus may comprise means for associating the modification profile with identification information of said user, and means for selecting said modification profile using said identification information for use in the modification of subsequent eye images featuring said user.

The apparatus may comprise means for providing a modification profile, said modification profile comprising a reference modification derived from a determined difference between a first contour corresponding to an upper eyelid in the eye image and a second reference contour corresponding to the same upper eyelid as depicted in the second eye image.

The apparatus may comprise means for providing a modification profile, said modification profile additionally including iris repositioning data derived by a comparison between a first relative position of an iris in the eye image and a second relative reference position of the same iris as depicted in the second eye image, the relative positions comprising the position of the iris relative to a different part of the eye in each of the eye image and second eye image.

The apparatus may comprise means for providing a modification to a contour of an eyelid featured in an eye image for use in image manipulation to adjust the eye shape to appear as having a gaze directly at a viewer based on an offset, in the eye image, from an eye shape of an eye having a gaze directly at a viewer, said offset determined using a predetermined modification profile representing a normalisation modification to adjust the eye shape from an eye having a gaze not directly at a viewer to a gaze directly at said viewer. The apparatus may comprise means for modifying the effect of the modification profile based on a determined distance indicative of the distance said eye is from a camera used to capture said eye image. The apparatus may include means for determining the distance by using a comparison between said eye image and a reference image used to form said modification profile.

The apparatus may comprise means for performing feature detection to identify the contour in the image corresponding to an eyelid of the eye featured in said image in response to receipt of the eye image.

The apparatus may comprise means for providing a further modification to an image area containing said iris for use in image manipulation to adjust the iris position to appear as having a gaze directly at a viewer based on an offset, in the eye image, from an iris position of an eye having a gaze directly at a viewer.

The apparatus may comprise means for modifying said eye image such that the eye appears to have a gaze directly at a viewer, based on said modification.

The apparatus may comprise means for providing a modification to a contour of an eyelid featured in said eye image for use in image manipulation, wherein the contour comprises an area corresponding to an upper eyelid featured in said image.

The apparatus may comprise means for providing front-facing camera functionality and means for providing front-facing display functionality. Said means for providing front-facing display functionality may be configured to display images captured by said front-facing camera functionality. The apparatus may comprising means for providing a modification to a contour of an eyelid featured in an eye image for use in image manipulation to adjust the eye shape to appear as having a gaze directly at a viewer based on an offset, in the eye image, from an eye shape of an eye having a gaze directly at a viewer, and said offset may comprise the difference in eye shape between an eye looking directly at the means for providing front-facing display functionality and an eye looking directly at the means for providing front-facing camera functionality.

The apparatus may comprise means for providing a modification to a contour of an eyelid featured in an eye image for use in image manipulation, the eye image comprising a live image and said apparatus comprising means for providing for display, in real time, a manipulated image created using said modification.

The apparatus may comprise means for using feature detection to identify a user present in said eye image and select a corresponding modification profile.

The apparatus may comprise means for providing a modification to a contour of an eyelid featured in an eye image for use in image manipulation, wherein the eye image comprises a selfie image and said apparatus comprises means for providing said modification to alter the shape of the contour to adjust the apparent gaze of a user featured in said selfie image such that it appears to be directed directly at a viewer of said eye image.

The present disclosure includes one or more corresponding aspects, examples or features in isolation or in various combinations whether or not specifically stated (including claimed) in that combination or in isolation. Corresponding means and corresponding functional units (e.g. modification provider, image manipulator, eye shape adjuster, gaze determiner) or performing one or more of the discussed functions are also within the present disclosure.

Corresponding computer programs for implementing one or more of the methods disclosed are also within the present disclosure and encompassed by one or more of the described examples.

One example of an embodiment of a method comprises:
determining an offset between a perceived direction which an eye feature is oriented towards in a facial image and a perceived direction of eye gaze in the eye feature in the facial image, and
modifying the eye feature to re-align the perceived direction of eye gaze with the perceived direction which the eye feature is oriented towards by changing at least the outline shape of at least one of the lower or upper eyelid outline shapes in the eye feature.

Thus, the when taking a self-portrait photograph, the eye feature may be oriented towards the camera lens used to capture the image, but the user's eye gaze may be directed away from the camera lens (to look at a display, for example). The method may thus modify at least one of the upper or lower eyelid in the image so that the perceived eye gaze also “faces”, or is oriented in, a direction directly towards the camera lens.

The perceived directions may be as perceived by a camera lens, for example, in a forwards facing camera.

One example of an embodiment of an apparatus comprises:
means for determining an offset between a perceived direction which an eye feature is oriented towards in a facial image and a perceived direction of eye gaze in the eye feature in the facial image; and
means for modifying the eye feature to re-align the perceived direction of eye gaze with the perceived direction which the eye feature is oriented towards by changing at least the outline shape of at least one of the lower or upper eyelid outline shapes in the eye feature.

Another example of an apparatus may comprise at least one processor and at least one memory including computer program code, the at least one memory and the computer program code configured to, with the at least one processor, cause the apparatus to perform at least the following:
determining an offset between a perceived direction which an eye feature is oriented towards in a facial image and a perceived direction of eye gaze in the eye feature in the facial image, and
modifying the eye feature to re-align the perceived direction of eye gaze with the perceived direction which the eye feature is oriented towards by changing at least the outline shape of at least one of the lower or upper eyelid outline shapes in the eye feature.

The above apparatus may determine a perceived direction as being a direction perceived by a camera lens having a field-of-view which includes the facial image. The perceived directions may be those perceivable in an image of the field-of-view of the camera lens by a viewer. The camera lens may comprise a forwards-facing camera and the viewer perceiving the facial image in the displayed image of the camera lens field-of-view may, for example, be a subject whose facial image is being displayed.

The above summary is intended to be merely exemplary and non-limiting.

### BRIEF DESCRIPTION OF THE FIGURES

A description is now given, by way of example only, with reference to the accompanying drawings, in which:

FIG. 1 illustrates an example apparatus embodiment comprising a number of electronic components, including memory and a processor, according to embodiments of the present disclosure;

FIG. 2 illustrates an example apparatus embodiment comprising a number of electronic components, including memory, a processor and a communication unit, according to embodiments of the present disclosure;

FIG. 3 illustrates an example apparatus embodiment comprising a number of electronic components, including memory and a processor, according to embodiments of the present disclosure;

FIGS. 4a-4d illustrate self-snapshots having eye gaze directed away from a viewer and eye gaze directed directly towards a viewer, according to embodiments of the present disclosure;

FIGS. 5a-5b illustrate eye gaze angles from a camera of an electronic device at different camera-eye separation distances, according to an embodiments of the present disclosure;

FIG. 6 illustrates different portions and contours of an image of an eye which may be used in analysing an eye image, according to embodiments of the present disclosure;

FIGS. 7a-7d illustrate modification to a contour of an eyelid, and modification of an iris/pupil position, according to embodiments of the present disclosure;

FIGS. 8a-8b illustrate modification to a contour of an eyelid according to embodiments of the present disclosure;

FIGS. 9a-9b illustrate an electronic device in communication with a remote server and a cloud according to embodiments of the present disclosure;

FIG. 10 illustrates a flowchart according to a method of the present disclosure; and

FIG. 11 illustrates schematically a computer readable medium providing a program.

### DESCRIPTION OF EXAMPLE ASPECTS

Certain electronic devices, for example a digital camera or a smartphone equipped with a digital camera, or a smart television connected to a camera, allow a user to capture images. Certain electronic devices, such as smartphones and tablet computers, comprise a front-facing camera. If a user looks at the display of the tablet/smartphone, the front-facing camera is directed towards the user's face. Using such a front-facing camera, a user can take a photograph of his/her own face (that is, the user can capture a “self-snapshot” or “selfie”). The user can see how the image will look using the display of the device, and capture the image of his/her face.

If a subject has his/her photograph taken by another person, the subject will usually look towards the camera (lens) when the photograph is taken. This can give the expected appearance of the subject looking out of the photograph towards the person viewing the final photograph.

A user may find a problem with capturing a self-snapshot, in that the user's eyes may not appear to be directed towards the camera (lens) and instead appear to be focussed away from the camera in another direction due to the layout of the camera and display. The user therefore may not appear to be looking out at the person viewing the image. This can occur, for example, if the user captures the self-snapshot using a device having a front-facing camera located above the screen display area. The user will typically look at the screen to see their own face prior to taking the photograph. Then, the front-facing camera captures the user looking at the screen, and thus below the camera. The user's sight line is not towards the camera and instead is focussed downwards. The resulting image can appear unnatural and unexpected because the user's gaze in the image is offset from a gaze directly towards the viewer. Of course, if the user held the same device in a landscape orientation then the camera would be to one side of the display and the user may appear to be looking sideways in the image. The following examples generally discuss a user looking downwards at a display below a camera.

Certain embodiments disclosed herein may be considered to, based on an offset, in an eye image, from an eye shape of an eye having a gaze directly at a viewer, provide a modification to a contour of an eyelid featured in the eye image for use in image manipulation to adjust the eye shape to appear as having a gaze directly at a viewer. Thus a user may capture a self-snapshot while looking at the display screen of the image capture device (such as a smartphone). The user's eye shape in the image may appear offset from an eye shape of an eye having a gaze directly at a viewer, as would be expected from a user who is looking at the camera (rather than the display screen) at the time of image capture. The apparatus can provide a modification to a contour of an eyelid featured in the eye image for use in image manipulation to adjust the eye shape to appear as having a gaze directly at a viewer. Thus the eye region in the image may be modified to give the appearance of the user looking at the viewer, as if the user had looked at the camera when the image was taken. This may improve the appearance of a self-snapshot image while allowing a user to take the photograph intuitively, namely, while looking at the display rather than away from the display at the camera.

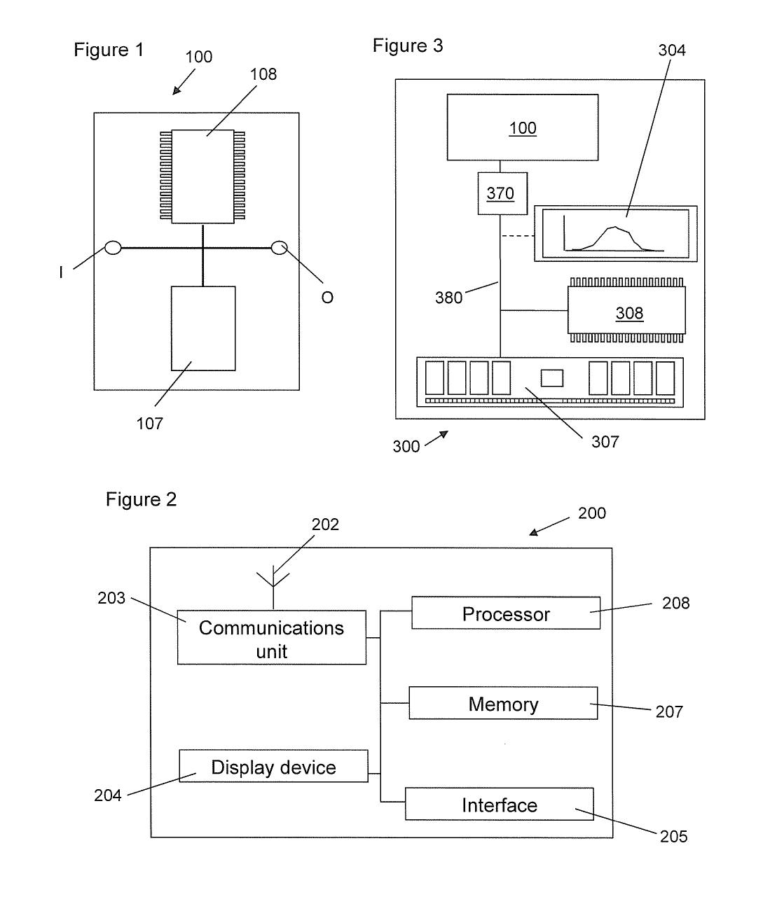

FIG. 1 shows an apparatus 100 comprising memory 107, a processor 108, input I and output O. In this embodiment only one processor and one memory are shown but it will be appreciated that other embodiments may utilise more than one processor and/or more than one memory (e.g. same or different processor/memory types).

In this embodiment the apparatus 100 is an Application Specific Integrated Circuit (ASIC) for a portable electronic device with a touch sensitive display. In other embodiments the apparatus 100 can be a module for such a device, or may be the device itself, wherein the processor 108 is a general purpose CPU of the device and the memory 107 is general purpose memory comprised by the device.

The input I allows for receipt of signalling to the apparatus 100 from further components, such as components of a portable electronic device (like a touch-sensitive or hover-sensitive display) or the like. The output O allows for onward provision of signalling from within the apparatus 100 to further components such as a display screen, speaker, or vibration module. In this embodiment the input I and output O are part of a connection bus that allows for connection of the apparatus 100 to further components.

The processor 108 is a general purpose processor dedicated to executing/processing information received via the input I in accordance with instructions stored in the form of computer program code on the memory 107. The output signalling generated by such operations from the processor 108 is provided onwards to further components via the output O.

The memory 107 (not necessarily a single memory unit) is a computer readable medium (solid state memory in this example, but may be other types of memory such as a hard drive, ROM, RAM, Flash or the like) that stores computer program code. This computer program code stores instructions that are executable by the processor 108, when the program code is run on the processor 108. The internal connections between the memory 107 and the processor 108 can be understood to, in one or more example embodiments, provide an active coupling between the processor 108 and the memory 107 to allow the processor 108 to access the computer program code stored on the memory 107.

In this example the input I, output O, processor 108 and memory 107 are all electrically connected to one another internally to allow for electrical communication between the respective components I, O, 107, 108. In this example the components are all located proximate to one another so as to be formed together as an ASIC, in other words, so as to be integrated together as a single chip/circuit that can be installed into an electronic device. In other examples one or more or all of the components may be located separately from one another.

FIG. 2 depicts an apparatus 200 of a further example embodiment, such as a mobile phone. In other example embodiments, the apparatus 200 may comprise a module for a mobile phone (or PDA or audio/video player), and may just comprise a suitably configured memory 207 and processor 208.

The example embodiment of FIG. 2 comprises a display device 204 such as, for example, a liquid crystal display (LCD), e-Ink or touch-screen user interface. The apparatus 200 of FIG. 2 is configured such that it may receive, include, and/or otherwise access data. For example, this example embodiment 200 comprises a communications unit 203, such as a receiver, transmitter, and/or transceiver, in communication with an antenna 202 for connecting to a wireless network and/or a port (not shown) for accepting a physical connection to a network, such that data may be received via one or more types of networks. This example embodiment comprises a memory 207 that stores data, possibly after being received via antenna 202 or port or after being generated at the user interface 205. The processor 208 may receive data from the user interface 205, from the memory 207, or from the communication unit 203. It will be appreciated that, in certain example embodiments, the display device 204 may incorporate the user interface 205. Regardless of the origin of the data, these data may be outputted to a user of apparatus 200 via the display device 204, and/or any other output devices provided with apparatus. The processor 208 may also store the data for later use in the memory 207. The memory 207 may store computer program code and/or applications which may be used to instruct/enable the processor 208 to perform functions (e.g. read, write, delete, edit or process data).

FIG. 3 depicts a further example embodiment of an electronic device 300, such as a tablet personal computer, a portable electronic device, a portable telecommunications device, a server or a module for such a device, the device comprising the apparatus 100 of FIG. 1. The apparatus 100 can be provided as a module for device 300, or even as a processor/memory for the device 300 or a processor/memory for a module for such a device 300. The device 300 comprises a processor 308 and a storage medium 307, which are connected (e.g. electrically and/or wirelessly) by a data bus 380. This data bus 380 can provide an active coupling between the processor 308 and the storage medium 307 to allow the processor 308 to access the computer program code. It will be appreciated that the components (e.g. memory, processor) of the device/apparatus may be linked via cloud computing architecture. For example, the storage device may be a remote server accessed via the internet by the processor.

The apparatus 100 in FIG. 3 is connected (e.g. electrically and/or wirelessly) to an input/output interface 370 that receives the output from the apparatus 100 and transmits this to the device 300 via data bus 380. Interface 370 can be connected via the data bus 380 to a display 304 (touch-sensitive or otherwise) that provides information from the apparatus 100 to a user. Display 304 can be part of the device 300 or can be separate. The device 300 also comprises a processor 308 configured for general control of the apparatus 100 as well as the device 300 by providing signalling to, and receiving signalling from, other device components to manage their operation.

The storage medium 307 is configured to store computer code configured to perform, control or enable the operation of the apparatus 100. The storage medium 307 may be configured to store settings for the other device components. The processor 308 may access the storage medium 307 to retrieve the component settings in order to manage the operation of the other device components. The storage medium 307 may be a temporary storage medium such as a volatile random access memory. The storage medium 307 may also be a permanent storage medium such as a hard disk drive, a flash memory, a remote server (such as cloud storage) or a non-volatile random access memory. The storage medium 307 could be composed of different combinations of the same or different memory types.

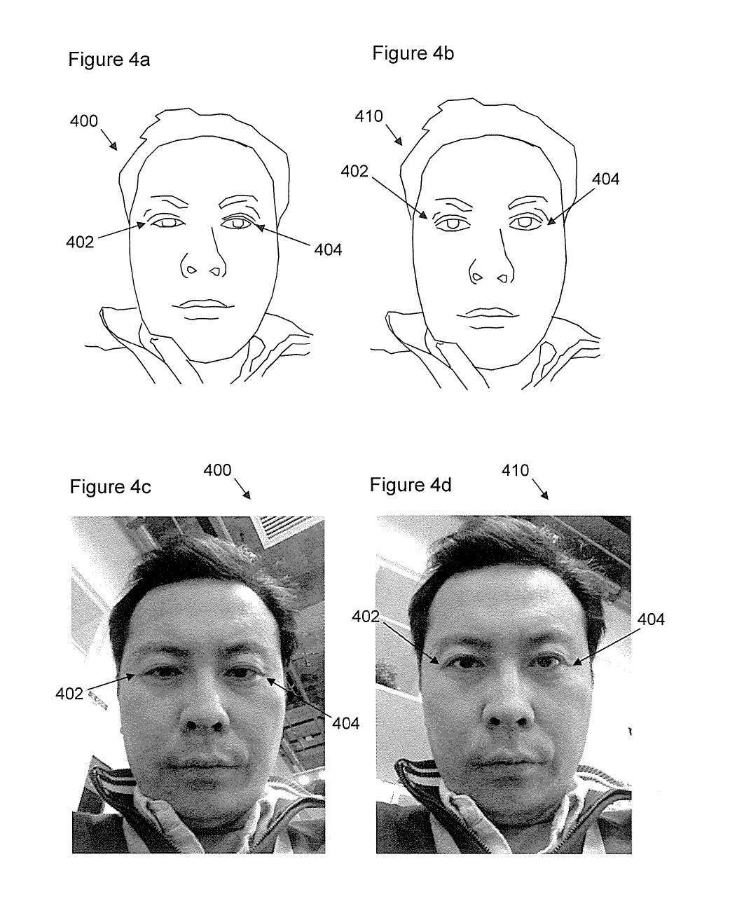

FIGS. 4a-4d schematically illustrate self-snapshots 400, 410 (which are also known as “selfies”). The images 400, 410 may be considered to be eye images as they include the user's eyes. FIG. 4c is a photographic image corresponding to FIG. 4a, and FIG. 4d is a photographic image corresponding to FIG. 4b. The self-snapshot images 400, 410 may be recorded, for example, by a user using an image capture device such as a camera-equipped smartphone, tablet computer, digital camera, or other camera-equipped portable electronic device.

In FIGS. 4a and 4c the user's eye gaze is directed away from the person viewing the photograph because the user was looking below the camera when taking the image 400 (he was looking at a display screen below the camera when taking the photo 400) so his eye gaze is offset from a gaze directly at the viewer. The user's eyes 402, 404 appear to be focussed away from the person viewing the photograph. It will be appreciated that, depending on the relative arrangement of the image capture device's display and camera, the user's gaze may be offset in any direction.

In FIGS. 4b and 4d the user's eye gaze is directed towards a viewer because the user was looking directly at the camera when taking the image 410. His eye gaze is directed directly at the viewer (that is, the user's eyes 412, 414 appear to be focussed at the person viewing the photograph).

A similar effect to that in FIGS. 4b and 4d may be achieved by processing the image 400 of FIGS. 4a and 4c to adjust the image of the eye 402, 404 to make it looks like that the eye 402, 404 is looking straight ahead at the viewer instead of looking down away from the viewer. This may be achieved by providing a modification to the contours of the eyelids in the image 400, so that the eye shape is adjusted to give the appearance of the user's gaze being directed towards the camera (and viewer). The modification can then be used for image manipulation to make changes to the image. Such modification may be advantageous since the user may find it much easier to capture an image they are happy with if they are able to see how they look in the display when taking the image. If the user is required to physically look at the camera when taking the image, the user's hand or face may move just prior to taking the image and the captured image may not be framed as desired or the user may not have the expression they wanted. Further, a user may simply intuitively look at the display when capturing the self-snapshot, and may find it very unintuitive and difficult not to look at the live image of him/herself on screen when capturing the image.

In some examples, a calibration (which can be thought of as a test, a training exercise, or a reference) may be carried out to create a modification profile. The images in FIGS. 4b and 4d may be considered to be calibration/reference images. The modification profile may be derived by a comparison between an eye image featuring an eye of a user not looking directly at a camera that is used to capture said eye image (for example, looking at a smartphone display with the camera positioned above the display) and a second, reference eye image featuring the eye of the user looking directly at the camera. The modification profile may be of one eye, or of two eyes, of a user. In some examples the same apparatus may create the modification profile and provide the modification to the contour of an eyelid. In other examples, a separate apparatus may create a modification profile and pass the profile onto the apparatus for providing the actual modification to the image.

In some examples, the first eye image featuring an eye of a user not looking directly at a camera as in FIGS. 4a and 4c may be compared with the second, reference eye image featuring the eye of the user looking directly at the camera as in FIGS. 4b and 4d to determine the difference in eye shapes/positions between the two images. The determined difference may then be used to modify subsequent images to adjust the eye gaze to appear as if the eyes are looking at the viewer. Thus, the modification profile may comprise the reference image which is used with a subsequent eye image to determine the offset and provide the modification. The modification profile may comprise relative measurements of the eye shapes in the reference eye image. It will be appreciated that the modification profile may contain information in any appropriate format for providing a reference from which an offset in eye shape may be determined, and an appropriate modification determined.

In some examples, the user may have captured a reference eye image such as in FIGS. 4b and 4d featuring the eye of the user looking directly at the camera. Then, upon subsequently capturing an eye image featuring an eye of a user not looking directly at a camera such as FIGS. 4a and 4c, this image may be compared with the reference image to determine the difference in eye shapes/positions between the two images and use the difference to modify the subsequent image to adjust the eye gaze to appear as if the eyes are looking at the image viewer.

In some examples, the modification profile may be associated with identification information of a particular user. The identification information may be used to select a modification profile for that particular user for use in the modification of subsequent eye images featuring the same user. For example, different users are likely to have different eye shapes. Thus for each user, a particular modification profile may be established for each user which relates personally to his/her eye shape. By having a modification profile for each user the resulting modified eye image may provide an improved, more natural result. Also, by storing a modification profile for each user, the user need not capture a calibration/test image each time they wish to use the device. The identification information may be, for example, recognition of a user's face, eye or iris using a facial recognition algorithm, or identification through the user inputting a passcode or similar identifier prior to using the device to capture a self-snapshot. By “training” the apparatus to provide a modification to a contour of an eyelid for individual users, advantageously the improvement to the eye image can be tailored for different users.

The modification profile may comprise a reference modification derived from a determined difference between a first contour corresponding to an upper eyelid in the eye image and a second reference contour corresponding to the same upper eyelid as depicted in the second eye image. The difference may be determined, for example, as a shift of the upper eyelid contour by a number of pixels (e.g. two pixels close to the corners and four pixels above the iris), a shift according to a mathematical expression (e.g. defining a particular curve/contour), or by feature-matching between a reference image and another image (in which the user's eye gaze is offset from a gaze directed towards the viewer of the image).

The upper eyelid contour (or any eyelid contour) may be, for example, the curve of the lash-line, a poly-line constructed from the lash-line, a poly-line corresponding to an edge between an upper eyelid and an eyeball featured in the eye image, or an area defined by the lash line and an upper bound of the upper eyelid region. Such contours may be identified using edge detection, for example. The appearance of the eyelid shape, in particular the upper eyelid, may change more significantly than other regions of the eye between a user looking down when an image is captured and a user looking at the camera during image capture.

Obtaining the modification profile by comparing a reference eye image taken while a user is looking at the camera (and thus the eye shape appears as having a gaze directly at a viewer) and another image where the user is looking at the display of the device (and thus the eye shape has an offset from an eye having a gaze directly at a viewer) may be thought of as “training” the apparatus/device.

In certain examples as discussed above, a calibration/reference image in which the eye shape appears as having a gaze directly at a viewer may be captured and compared with an image in which the user is not looking directly at the camera (and therefore there is an offset from an eye shape having a gaze directly at the viewer). In other examples a reference image may not be taken. For example, the apparatus (or another apparatus) may determine one or more eye landmarks and based on the landmark positions, use predetermined generic eye shape data to modify the appearance of an upper eyelid (and possibly the iris and pupil positions). Thus the offset from the eye shape of an eye having a gaze offset from a gaze directly at a viewer may be determined using predetermined generic eye shape data representing a normalisation modification to adjust the eye shape from an eye having a gaze not directly at a viewer to a gaze directly at said viewer. The apparatus providing the predetermined generic eye shape data may or may not also determine the offset.

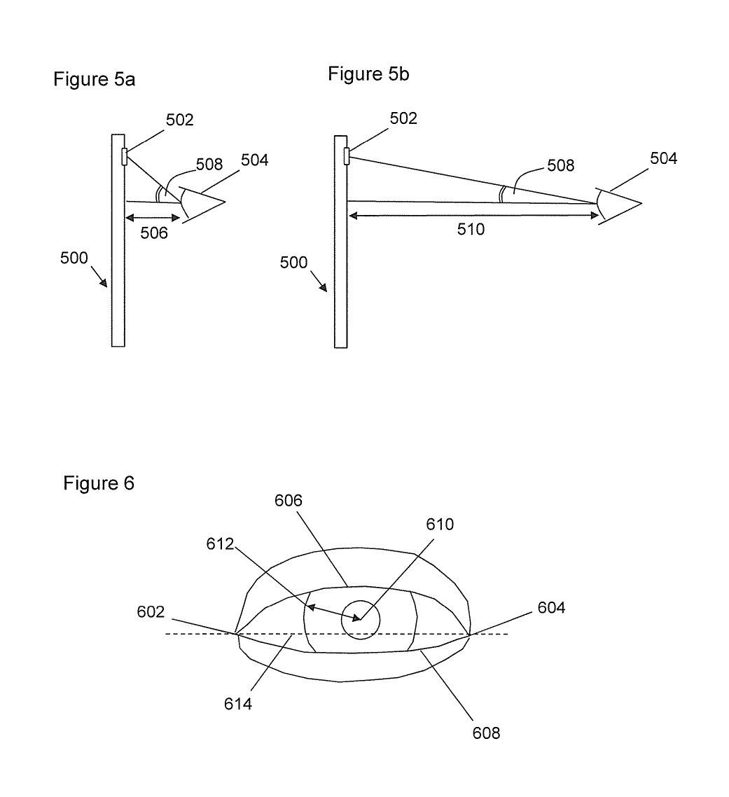

Also in some examples, the closer the user's face is to the camera, the more significant the differences between upper eyelid positions and/or the position of the iris and pupil is likely to be. That is, the distance between the user's face and a front-facing camera may have an effect on how to best to adjust the eye image. Therefore if a user is taking a self-snapshot by holding a device close to their face, then the position of the upper eyelid and/or iris and pupil will change more significantly between a user looking at the camera and looking at the screen than if the user was holding the device at arm's length. This is illustrated in FIGS. 5a-5b. It may be said that the effect of the modification profile may be based on a determined distance indicative of the distance said eye is from a camera used to capture said eye image. In some examples the distance may be determined by a comparison between the eye image and a reference image used to form the modification profile. The reference image may be required to be taken at a particular distance or within a particular distance range in some examples.

In FIGS. 5a-5b, the user is taking a self-snapshot using a camera 502 which is part of a portable electronic device 500, such as a smartphone. The user is looking at the display screen of the device 500 while taking the photograph. The apparatus/device in this example comprises a front-facing camera 502 and a front-facing display. The front-facing display is configured to display images captured by said camera 502. An offset may be determined which comprises the difference in eye shape between an eye looking directly at the display and an eye looking directly at the camera 502, for example, as may result when a user takes a self-snapshot using the apparatus/device 500.

The extent to which the eye image needs to be adjusted to give an eye shape having a gaze directed at a viewer can be affected by how far the user's face (or eye) is away from the camera. FIGS. 5a and 5b described below show that the modification may need to be greater as the user's face/eye is closer to the camera.

In FIG. 5a, the user's face (and eyes 504) are relatively close 506 to the device 500 and camera 502. Thus the angular offset 508 of the user's gaze from the camera 502 is relatively large and the appearance of the user's eyes gazing far away from the line of sight of a viewer of the photograph is likely to be very noticeable. In FIG. 5b, the user's face (and eyes 504) are relatively far 510 from the device 500 and camera 502. Thus the angular offset 508 of the user's gaze from the camera 502 is relatively small and the appearance of the user's eyes gazing just a small offset away from the line of sight of a viewer of the photograph is unlikely to be very noticeable.

The effect of the distance between the camera and the user's face/eye may be considered in terms of two lines of sight: the first line of sight is from user's pupil to the point on screen where the user is focussing. The second line of sight is from the user's pupil to the front-facing camera. If the angle between these two lines of sight is zero, then the problem of a user's gaze appearing to be offset from a viewer of the image of the user does not exist and no adjustment/modification of the eye image is required. If the angle between the two lines of sight is non-zero, then the viewer of the image of the user may have the impression that the eye in the picture does not look straight ahead at the viewer (because the eye was not looking at the camera when the image was taken). The closer the user's face is to the front-facing camera, the bigger the angle between the two lines of sight is, and thus the offset of the user's gaze in the image is more pronounced and may need a greater adjustment.

In some examples, a measure of how far the user's eye is from the screen may be determined. This can be determined, for example, by the length of the line connecting the two corners of the eye (corners 602 and 604 in FIG. 6). The length of this length (in units of pixels for example) in the image can be used to measure how far away the user's eye is from the screen. The longer the connecting line is, the closer the user's face is to the screen. Next, a reference “camera-eye separation” distance may be set as a base for making the adjustment/modification to the eye image. The reference distance may be a reference distance obtained from a “training” or calibration image, or may be a distance previously provided by the user corresponding to the user's arm length when taking a self-snapshot, for example. As an example the reference distance may be 30 cm. At this distance, it may be determined that the iris position needs to be adjusted by upwards translation in the image by 10 pixels to make it appear as if the user is looking at the camera in the image (such that the eye gaze is directed towards a viewer of the image). It may also be determined, for example, that at a much larger camera-eye separation of 200 cm, no adjustment/modification to the eye image needs to be made because the effect of the user looking at the display screen rather than the camera is negligible and the image anyway appears such that the eye gaze in the image is directed at the image viewer. Based on these reference measurements, the number of pixels by which the iris position should be moved upwards in the image may be calculated. A formula for determining the pixel number is M=(200−d)/17, where M represents the number of pixels to move, and d is the distance between the user's face/eye and camera/screen in cm. It can be seen from this formula that if d is smaller than 30, then the adjustment value will be even larger than 10 pixels, which is as expected and reasonable. This example relating to pixel adjustment for the iris position is equally applicable to the pixel adjustment required to move the upper eyelid position. It will be appreciated that other formulae may be used, or other functions that describe a shape to be achieved.

In one example, firstly the apparatus/device needs to determine a modification profile (which may comprise one or more parameters, formulae or instructions) by comparing reference and non-reference images. The comparison can be used to calculate how to adjust the position of, for example, the upper eyelid contour and iris of the eye in the image. This step may only need to be done once to establish the difference in the two types of eye image. Next follows the provision of the modification and the use of the modification in the actual image adjustment process, where the apparatus/device can adjust the position of iris and eyelid in a self-snapshot image by using the modification profile determined in the first step. When making the adjustment the distance between the user and the camera may be taken into account.

For example, if a user is taking a self-snapshot using a camera-equipped smartphone, the smartphone may provide instructions to a user. Firstly, the phone may tell a user to hold the smartphone in the normal self-snapshot position and to look at the display screen of the smartphone to see the image to be captured. The front-facing camera can then capture the image when the user's face and eyes are in this position. This image may be called a “screen position image” as in FIGS. 4a and 4c. Next, the smartphone may tell a user to look at the front-facing camera directly. The camera will then take another image for this eye shape/position. This image may be called a “camera position image” or reference image as in FIGS. 4b and 4d.

The reference “camera position image” and non-reference “screen position image” may then be analysed using image processing techniques such as edge detection. FIG. 6 illustrates different portions and contours of an image of an eye in an eye image 600. Regions of the eye area which may be identified may include an inner corner 602 and an outer corner 604, an upper eyelid contour 606 and a lower eyelid contour 608, and the centre of the pupil 610 (which would also be the centre of the iris). Also indicated are the radius of the iris 612 and a horizontal reference line 614 which passes through and connects the inner and outer corners of the eye 602, 604. The location of the centre of the pupil/iris 610 with respect to the horizontal reference line 614 may also be determined.

Between the reference “camera position image” and non-reference “screen position image”, the locations of the eye corners 602, 604, the radius of the iris 612 and the contour of the lower eyelid 608 should be substantially the same. However, the iris centre 610 and the contour of the upper eyelid 606 are likely to differ between the two images.

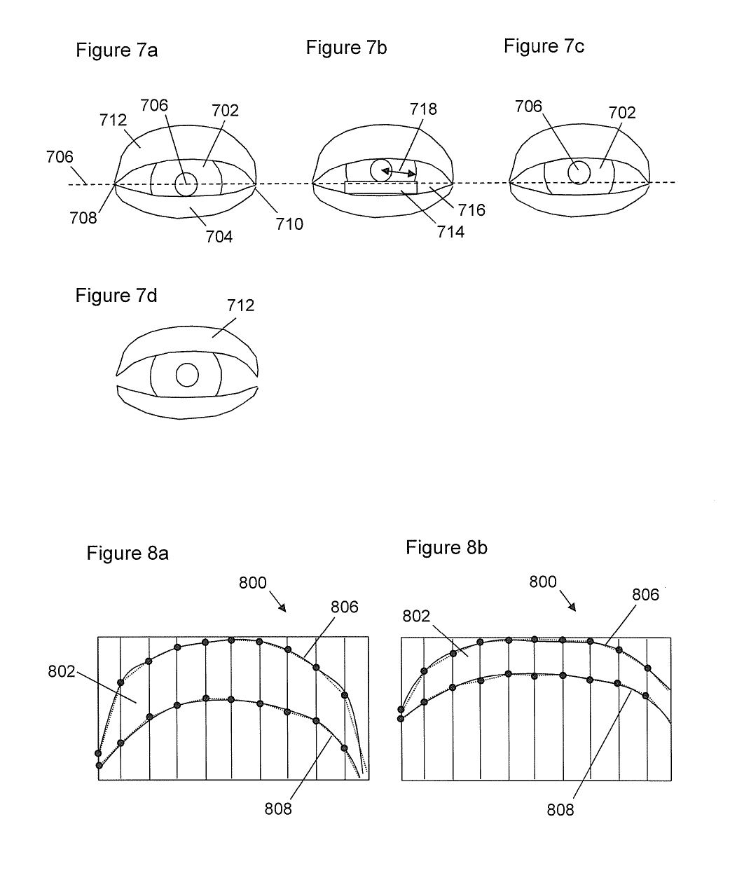

The regions illustrated in FIG. 6 may be used to analyse an eye image to create a modification profile for use in subsequent eye image manipulation. FIGS. 7a-7d show the steps of determining the modification and using the modification to manipulate the image in an image editing step. Such regions may be identified by the apparatus response to receipt of the eye image by performing feature detection to identify, for example, the contour in the image corresponding to an eyelid of the eye featured in said eye image (or one or more other eye features as described above).

FIGS. 7a-7d illustrate how an image taken while a user is looking at the display (rather than the camera) may be modified to adjust the eye gaze such that it is directed at a viewer.

FIG. 7a shows an eye image 700 of an eye captured when the user was looking below the camera at the display screen. To modify the image such that the gaze of the eye is directed toward the image viewer rather than the gaze being offset from directly toward the viewer, the position of the iris 702 needs to be moved vertically up. This can be achieved by moving the pixels in the iris area 702 vertically up away from the lower eyelid 704. To determine by how much to move the iris pixels, the centre point of the iris 706 may be determined and the number of pixels difference between the centre of the iris in reference and non-reference images, or as recorded in the modification profile, may be determined. If a difference of 10 pixels is found, the centre of the iris (and thus the region of the eye image 700 corresponding to the iris 702) may be moved vertically up by 10 pixels.

An image in which the iris area 702 has been moved vertically up is shown in FIG. 7b. The moved iris area 702 should not overlap the upper eyelid area 712. Edge detection may be used to identify one or more edges in the eye image, such as the lash line of the upper eyelid. The upper eyelid area 712 may be identified as a separate layer in the eye image which is always in front of the layer of the image on which the iris area 702 is included. In other words, pixels in the upper eyelid area 712 are treated as a front-most layer and pixels in the iris layer 702 are treated as a layer underneath the upper eyelid area 712. This ensures that if pixels of these two layers overlap after moving the iris area 702, the pixels of the upper eyelid region 712 are used and displayed rather than the iris area pixels 702.

FIG. 7b also shows that, after moving iris area 702 vertically upward, there remains a blank area 714 with undetermined pixel values. This blank area 714 is the area between the original bottom boundary of the visible iris area 702 and the top line of lower eyelid 704. This blank area 714 needs to be processed to make the eye image overall 700 appear natural.

In one example, firstly the blank area 714 may be filled in using a pixel value matching that of the eye white 716 outside the iris area 702. Next, the region of the white-coloured area 714 which should correspond to the iris 702 is determined using the centre point of the iris/pupil 706 and the radius of the iris 718. Using the centre point 706 and the iris radius 718, the geometry of the iris to be include in the area 714 can be calculated. The iris region of the area 714 can be filled in using pixel values matching pixels within the existing iris area 702. Again, as with the upper eyelid overlaying the iris, so should the lower eyelid 704 so that, in the modified image, the iris appears to be behind the lower eyelid as it would appear for a real eye. This may be done using similar layer processing to that used when moving the iris area 702 vertically up in the image 700 and preventing the iris overlapping the upper eyelid 712.

At this stage the position of the iris and pupil have been modified to give the appearance of the eye image having a gaze directed towards a viewer of the image 700, as shown in FIG. 7c.

It may be said that based on an offset, in the eye image 700, from an iris position 706 of an eye having a gaze directly at a viewer, a modification is provided to an image area containing said iris 702 for use in image manipulation to adjust the iris position to appear as having a gaze directly at a viewer. The apparatus configured to so this may or may not be the same apparatus configured to provide a modification to a contour of an eyelid features in the eye image.

In FIG. 7c, the position of the upper eyelid 712 may appear unnatural due to the position of the iris being moved, as it was captured in relation to a user looking downwards. The upper eyelid appearance may be adjusted by using a shader program. In particular, vertex shading may be used. Vertax shading allows a non-liner transformation of an image to be performed. Vertax shading may require one or more items of information in order to perform the transformation, such as where a point ‘A’ in the original image should be moved to a point B′ in the final image. Such information may be considered to be a “modification”. Then the vertex shading algorithm may calculate how to map each point on the image to another point using an interpolation algorithm. FIGS. 8a and 8b provide further illustration of how this may be achieved. After modifying the upper eyelid shape/position the eye image may be as in FIG. 7d, such that the eye gaze appears directed at the viewer.

It may be said that the apparatus configured to provide the modification is further configured to use the modification to modify the eye image such that the eye appears to have a gaze directly at a viewer as in FIG. 7d. This may include, as detailed above, image manipulation to create an image portion of an iris not present in the original image which is necessitated by the modification (just above the lower eyelid upon moving the iris area upwards, and/or just below the lower line of the upper eyelid after modifying the appearance of the upper eyelid.)

It may be said that a modification profile provided by the apparatus may additionally include iris repositioning data derived by a comparison between a first relative position of an iris in the eye image and a second relative reference position of the same iris as depicted in the second eye image. For example, an upper eyelid contour and the position of the iris may be in a different position in a photograph of a user looking away from a camera and a user looking directly at a camera. The difference in iris position between the two images may be used to obtain iris repositioning data for subsequent amendment of eye images in which the user is not looking at the camera (and thus does not have an eye gaze focussed on the person viewing the image). The relative positions of the iris may comprise the position of the iris relative to a different part of the eye in each of the eye image and second eye image. For example, the iris position may be determined in reference to a lower eyelid contour, such as a lower lash-line, and/or an inner or outer corner of the eye (for example, if the user's gaze is not different only in a vertical direction between the two images).

FIGS. 8a and 8b show an upper eyelid region 802, 804 of an eye image 800. Each upper eyelid has been segmented into 10 columns. For each column, the upper and lower edges 806, 808 of the upper eyelid are identified. This may be done for all columns, for a non-reference eye image as in FIG. 8a and a reference eye image as in FIG. 8b. The apparatus configured to provide the modification may be configured to divide the upper eyelid region 802, 804 into at least two sub-areas and provide a modification to the shape of each of the sub-areas.

From this columnar analysis, the upper eyelid region of an eye image taken when the user's eye gaze is directed away from a viewer of the image may be modified to give an eye image in which the upper eyelid is in a position appropriate for a user's eye gaze directed at the viewer. Increasing the number of columns may increase the accuracy of this process (potentially requiring increasing processor power as the number of columns increases). Dividing into columns provides a convenient way of analysing and/or changing the eyelid shape/contour.

After raising the lower line of the upper eyelid as in FIG. 8b, a blank area may remain in the eye image similar to the blank area 714 in FIG. 7b which remains after adjusting the position of the iris. This may be treated in a similar way to fill in the blank area with iris and eye white colouring as described above.

Using a modification to modify an eye image such that the eye appears to have a gaze directed at a viewer may be implemented in different ways. In one example, the modification/adjustment operation may applied in real time to process a live image which the user can see in the display/view finder as displayed on screen. Thus, when the user looks/gazes at the screen, they actually see the adjusted picture as if they are looking at the camera rather than the display. In some examples it may give the result of a user looking in a mirror. The ideal result may be to appear as if a user is are looking in a mirror. A device configured to make such real-time adjustments may require a more powerful central processing unit (CPU) and/or graphical processing unit (GPU).

In another example, prior to taking the self-snapshot, the image of the user displayed in the view finder on screen may not be processed and may show the original image as captured by the front-facing camera. After the user presses the shutter button or triggers the shutter command to take the image, the adjustment/modification process may then start. When the captured image is presented to the user, in the short preview mode or when later viewed in a gallery application, for example, the image has been adjustment so that the user's eye gaze is directed to the viewer. This option may not require as powerful a CPU and/or GPU as the “real-time” adjustment option described above.

A further example may be that the captured self-snapshot is not adjusted automatically (either in real-time or automatically after capture). Instead, the user may be able to manually select an “eye gaze direction” adjustment option in an editing application for example, similar to selecting a “red eye reduction” feature which is known in photo editing software. This option may not require as powerful a CPU and/or GPU as the “real-time” adjustment option, and in some examples may not require as powerful a CPU and/or GPU as the “automatic adjustment after capture” option described above. In the “real-time” and “automatic adjustment after capture” options, the apparatus/device may allow a user to select in a user menu or similar whether or not they wish to activate the eye gaze direction adjustment feature or not.

The above examples generally discuss moving the position and reshaping (such as contour modification) of an upper eyelid contour and an iris/pupil upwards in an image to compensate for a user looking below a camera, as in the case of a user using a smartphone or table computer having a front-facing camera located above a display screen. Of course, if the camera is located below a display screen, the above discussion may be considered to apply in the case of adjusting an eye image such that the user's gaze is modified to look further downwards in the image, by modifying the upper eyelid contour (and/or lower eyelid contour in some examples) and the iris/pupil position downwards as if looking at the camera. An example may be of a user using a smart television having a camera located below the television screen and capturing a self-snapshot. In this way, a subject's eye gaze can be corrected to align with the orientation of other facial features in a facial image captured by a camera regardless of the direction which, at the point when the facial image is captured, the subject's gaze is directed. Of course, a user may be looking in any direction when capturing a photograph of themselves (e.g. sideways), and the resulting image may be modified to give the appearance of the user looking at the viewer in the image/looking at the camera lens when the image was captured. For example, the upper and/or lower lid may be modified and, optionally, the area and/or position and/or size of the iris and/or pupil adjusted, for example, if suitable configuration data for such modifications is provided.

In some embodiments, it may be possible to adjust the eye gaze to align this with the front-facing direction of the subject's face, so that even if the subject's face is being captured at a direction which is not equivalent to a full-frontal portrait by the camera, the eye gaze is corrected to align the eye gaze to a direction aligned with the orientation of the subject's features. One example embodiment of a method comprises: determining an offset between a perceived direction which an eye feature is oriented towards in a facial image and a perceived direction of eye gaze in the eye feature in the facial image, and modifying the eye feature to re-align the perceived direction of eye gaze with the perceived direction which the eye feature is oriented towards by changing at least the outline shape of at least one of the lower or upper eyelid outline shapes in the eye feature. In some embodiments, the offset in the subject's eye gaze to the direction in which their facial features are facing (i.e., the direction their face is frontally oriented towards), may be determined automatically. In some embodiments, additionally, or instead, the eye feature may be adjustable by a user to achieve a desired direction aligned with the desired or original eye gaze. The eye feature may be adjusted by modifying (diminishing or augmenting) one or more of: the top and/or bottom eyelid, iris, and pupil. Such modification may alter one or more of: a shape, size and/or position and the modification to the eye feature may be adjusted automatically in dependence on the original eye gaze direction, a user-selected eye gaze direction or an automatically corrected eye gaze direction which optimally orients the eye gaze, for example, according to one or more predetermined user-specified calibration criteria.

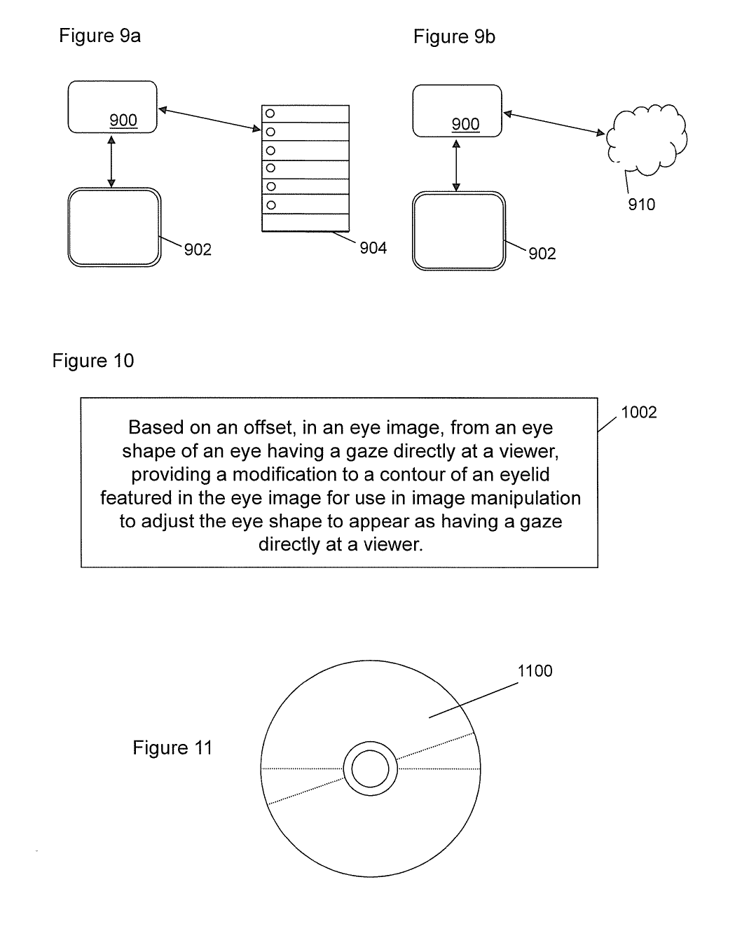

FIG. 9a shows an example of an apparatus 900 in communication with a remote server. FIG. 9b shows an example of an apparatus 900 in communication with a “cloud” for cloud computing. In FIGS. 9a and 9b, apparatus 900 (which may be apparatus 100, 200 or 300) is also in communication with a further apparatus 902. The apparatus 902 may be a digital camera, for example. In other examples, the apparatus 900 and further apparatus 902 may both be comprised within a device such as a portable communications device or PDA. Communication may be via a communications unit, for example.

FIG. 9a shows the remote computing element to be a remote server 904, with which the apparatus 900 may be in wired or wireless communication (e.g. via the internet, Bluetooth, NFC, a USB connection, or any other suitable connection as known to one skilled in the art). In FIG. 9b, the apparatus 900 is in communication with a remote cloud 910 (which may, for example, be the Internet, or a system of remote computers configured for cloud computing). For example, the apparatus performing adjustments to a digital image, or the apparatus identifying eye and eyelid regions of an image, may be located at a remote server 904 or cloud 910 and accessible by the first apparatus 900. In other examples the second apparatus may also be in direct communication with the remote server 904 or cloud 910.

FIG. 10 shows a flow diagram illustrating the method 1002 of, based on an offset, in an eye image, from an eye shape of an eye having a gaze directly at a viewer, providing a modification to a contour of an eyelid featured in the eye image for use in image manipulation to adjust the eye shape to appear as having a gaze directly at a viewer.

FIG. 11 illustrates schematically a computer/processor readable medium 1100 providing a program according to an example. In this example, the computer/processor readable medium is a disc such as a digital versatile disc (DVD) or a compact disc (CD). In other examples, the computer readable medium may be any medium that has been programmed in such a way as to carry out an inventive function. The computer program code may be distributed between the multiple memories of the same type, or multiple memories of a different type, such as ROM, RAM, flash, hard disk, solid state, etc.

The apparatus shown in the above examples may be a portable electronic device, a laptop computer, a mobile phone, a smartphone, a tablet computer, a smart television, a personal digital assistant, a navigation device, a watch, a digital camera, a non-portable electronic device, a server, a desktop computer, a monitor/display, or a module/circuitry for one or more of the same.

Any mentioned apparatus/device/server and/or other features of particular mentioned apparatus/device/server may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

In some examples, a particular mentioned apparatus/device/server may be pre-programmed with the appropriate software to carry out desired operations, and wherein the appropriate software can be enabled for use by a user downloading a “key”, for example, to unlock/enable the software and its associated functionality. Advantages associated with such examples can include a reduced requirement to download data when further functionality is required for a device, and this can be useful in examples where a device is perceived to have sufficient capacity to store such pre-programmed software for functionality that may not be enabled by a user.

Any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g. memory, signal).

Any “computer” described herein can comprise a collection of one or more individual processors/processing elements that may or may not be located on the same circuit board, or the same region/position of a circuit board or even the same device. In some examples one or more of any mentioned processors may be distributed over a plurality of devices. The same or different processor/processing elements may perform one or more functions described herein.

The term “signalling” may refer to one or more signals transmitted as a series of transmitted and/or received electrical/optical signals. The series of signals may comprise one, two, three, four or even more individual signal components or distinct signals to make up said signalling. Some or all of these individual signals may be transmitted/received by wireless or wired communication simultaneously, in sequence, and/or such that they temporally overlap one another.

With reference to any discussion of any mentioned computer and/or processor and memory (e.g. including ROM, CD-ROM etc.), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/examples may consist of any such individual feature or combination of features. In view of the foregoing description it will be evident to a person skilled in the art that various modifications may be made within the scope of the disclosure.

While there have been shown and described and pointed out fundamental novel features as applied to examples thereof, it will be understood that various omissions and substitutions and changes in the form and details of the devices and methods described may be made by those skilled in the art without departing from the scope of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or examples may be incorporated in any other disclosed or described or suggested form or example as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1-20. (canceled)

21. An apparatus comprising:
at least one processor; and
at least one memory including computer program code,
the at least one memory and the computer program code configured to, with the at least one processor, cause the apparatus to perform at least the following:
based on an offset, in an eye image, from an eye shape of an eye having a gaze directly at a viewer, provide a modification to a contour of an eyelid featured in the eye image for use in image manipulation to adjust the eye shape to appear as having a gaze directly at a viewer.

22. The apparatus of claim 21, wherein the eyelid comprises an upper eyelid of an eye in said eye image.

23. The apparatus of claim 21, wherein said modification provides a modification profile, said modification profile derived by a comparison between said eye image featuring an eye of a user not looking directly at a camera that is used to capture said eye image and a second reference eye image featuring the eye of the user looking directly at the camera.

24. The apparatus of claim 23, wherein said modification profile is associated with identification information of said user and said identification information is used to select said modification profile for use in the modification of subsequent eye images featuring said user.

25. The apparatus of claim 23, wherein said modification profile comprises a reference modification derived from a determined difference between a first contour corresponding to an upper eyelid in the eye image and a second reference contour corresponding to the same upper eyelid as depicted in the second eye image.

26. The apparatus of any one of claim 23, wherein said modification profile additionally includes iris repositioning data derived by a comparison between a first relative position of an iris in the eye image and a second relative reference position of the same iris as depicted in the second eye image, the relative positions comprising the position of the iris relative to a different part of the eye in each of the eye image and second eye image.

27. The apparatus of claim 21, wherein said offset is determined using a predetermined modification profile representing a normalisation modification to adjust the eye shape from an eye having a gaze not directly at a viewer to a gaze directly at said viewer.

28. The apparatus of claim 27, wherein the effect of the modification profile is based on a determined distance indicative of the distance said eye is from a camera used to capture said eye image.

29. The apparatus of claim 28, wherein the distance is determined by a comparison between said eye image and a reference image used to form said modification profile.

30. The apparatus of claim 21, wherein the apparatus is configured to, in response to receipt of the eye image, perform feature detection to identify the contour in the eye image corresponding to an eyelid of the eye featured in said eye image.

31. The apparatus of claim 21, wherein the apparatus is further configured to, based on an offset, in the eye image, from an iris position of an eye having a gaze directly at a viewer, provide a further modification to an image area containing said iris for use in image manipulation to adjust the iris position to appear as having a gaze directly at a viewer.

32. The apparatus of claim 21, wherein the apparatus is further configured to use said modification to modify said eye image such that the eye appears to have a gaze directly at a viewer.

33. The apparatus of claim 21, wherein the contour comprises an area corresponding to an upper eyelid featured in said eye image.

34. The apparatus of claim 21, wherein said apparatus comprises a front-facing camera and a front-facing display, said front-facing display configured to display images captured by said camera, and wherein said offset comprises the difference in eye shape between an eye looking directly at the display and an eye looking directly at the camera.

35. The apparatus of claim 21, wherein said eye image comprises a live image and said apparatus is configured to provide for display, in real time, a manipulated image created using said modification.

36. The apparatus of claim 21, wherein the apparatus is configured to use feature detection to identify a user present in said eye image and select a corresponding modification profile.

37. The apparatus of claim 21, wherein the eye image comprises a selfie image and said apparatus is configured to provide said modification to alter the shape of the contour to adjust the apparent gaze of a user featured in said selfie image such that it appears to be directed directly at a viewer of said eye image.

38. The apparatus of claim 21, wherein the apparatus is a portable electronic device, a laptop computer, a mobile phone, a smartphone, a tablet computer, a smart television, a personal digital assistant, a navigation device, a watch, a digital camera, a non-portable electronic device, a server, a desktop computer, a monitor/display, or a module/circuitry for one or more of the same.

39. A method, comprising
based on an offset, in an eye image, from an eye shape of an eye having a gaze directly at a viewer, providing a modification to a contour of an eyelid featured in the eye image for use in image manipulation to adjust the eye shape to appear as having a gaze directly at a viewer.

40. A computer readable medium comprising computer program code stored thereon, the computer readable medium and computer program code being configured to, when run on at least one processor, perform at least the following:
based on an offset, in an eye image, from an eye shape of an eye having a gaze directly at a viewer, provide a modification to a contour of an eyelid featured in the eye image for use in image manipulation to adjust the eye shape to appear as having a gaze directly at a viewer.
